(19) United States
(12) Patent Application Publication
(10) Pub. No.: US 2009/0089870 A1
(43) Pub. Date: Apr. 2, 2009

(54) System and method for validating interactions in an identity metasystem

(76) Inventor: Mark Frederick Wahl, Austin, TX (US)

Correspondence Address: Mark Wahl, PO Box 90626, Austin, TX, 78709, US

(21) Appl. No.: 12/286,042

(22) Filed: Sep. 27, 2008

Related U.S. Application Data
(60) Provisional application No. 60/995,984, filed on Sep. 28, 2007.

(51) Int. Cl. H04L 9/32; G06F 15/16; G06F 17/30

(52) U.S. Cl. 726/9

(57) ABSTRACT

An information processing system for a computing network in which information describing planned interactions between an identity selector and a relying party web site are provided to a validation service, compared with information a database, and a response returned to the identity selector.

### BACKGROUND OF THE INVENTION

1. Field of Invention

This invention relates generally to security in computer networks.

2. Prior Art

An Identity Metasystem is a collection of interoperable computing elements on a computer network which enables users of the services provided by the network to manage and exchange their digital identities. In an Identity Metasystem, an Identity Provider is a network server responsible for authenticating users, and a Relying Party is a network server which requires an authenticated user identity in order to provide service to that user. A prior art definition of the Identity Metasystem specifies the mechanisms that enable a Relying Party to validate that a user requesting service from that Relying Party has been previously authenticated by an Identity Provider, in which the Relying Party is a web service based on the Simple Object Access Protocol (SOAP), or web server based on the Hypertext Transfer Protocol (HTTP). HTTP is specified by the document IETF RFC 2616 “Hypertext Transfer Protocol—HTTP/1.1” by R. Fielding et al of June 1999. The Hypertext Transfer Protocol is typically used by a web browser to communicate with a web server to retrieve Hypertext Markup Language documents from a web application.

The document “A Technical Reference for the Information Card Profile V1.0”, published in December 2006 by Microsoft Corporation, describes the network communication protocols by which an Identity Selector may obtain the token requirements of a Replying Party, then authenticate to an Identity Provider, and finally send a token obtained from an Identity Provider to a Relying Party. The protocols defined in “A Technical Reference for InfoCard v1.0 in Windows” specify a protocol exchange in which the protocols defined in the documents Web Services Security: SOAP Message Security 1.0 (WS-Security 2004), Web Services Trust Language (WS-Trust), Web Services Security Policy Language (WS-SecurityPolicy) and Web Services Metadata Exchange (WS-MetadataExchange), all of which are based on the Simple Object Access Protocol (SOAP), are to be used for the communication between the Identity Selector and the Relying Party. The Simple Object Access Protocol is typically used only between applications in a web services framework.

The document “A Guide to Supporting InfoCard v1.0 Within Web Applications and Browsers”, published in March 2006 by Microsoft Corporation, describes the network communication protocols by which an Identity Selector may obtain the token requirements of a Relying Party and send a token obtained from an Identity Provider to a Relying Party using the Hypertext Transfer Protocol (HTTP) and Hypertext Markup Language (HTML).

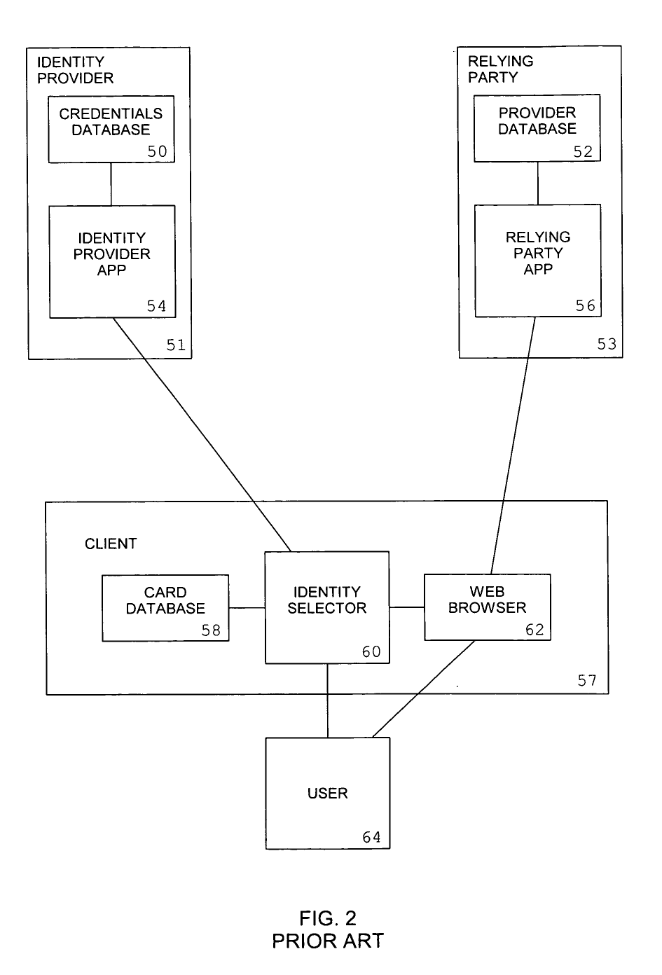

The diagram of FIG. 2 illustrates the prior art elements of a deployment of an identity metasystem. In this deployment, an identity selector component (60) of a client (57), under the direction of the client's user (64), authenticates the user at an identity provider (51). The identity provider application component (54) returns an indication of the user's authenticated identity to the identity selector component; the identity selector component provides this information to the web browser component (62), and the web browser component sends it to a relying party (53).

A limitation of the prior art is that a user may inadvertently provide an authenticated identity to a relying party which is not in accordance with the user's desired interactions with that relying party. Another limitation of the prior art is that an identity selector might inadvertently reveal a user's identity to a fraudulent relying party.

### SUMMARY

This invention describes a system and method for validating interactions in an identity metasystem to address the above-mentioned limitations. In this invention, a validation service (20) participates in the identity transfer interaction and provides an error indication to the user (36) should the interaction be likely to result in inappropriate disclosure or use of the user's identity.

### DRAWINGS

### Figures

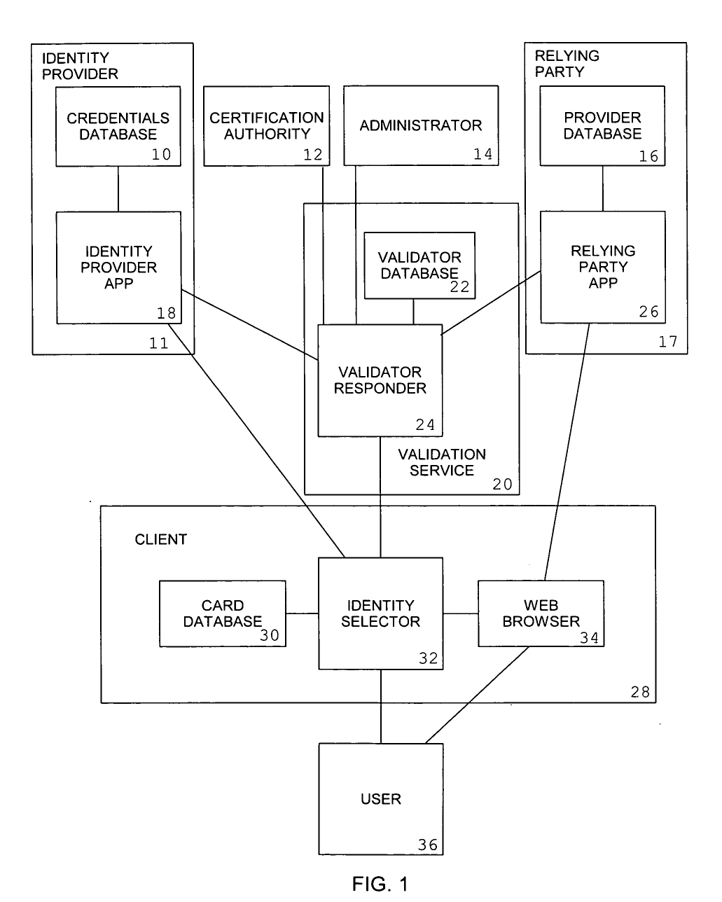

FIG. 1 is a diagram that illustrates the components of the system for validating interactions in an identity metasystem.

FIG. 2 is a diagram that illustrates the components of a prior art system.

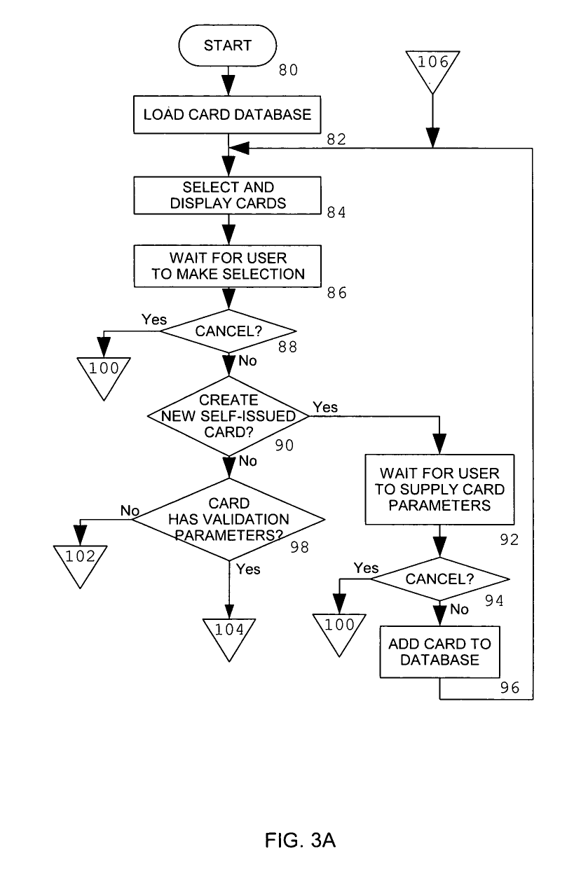

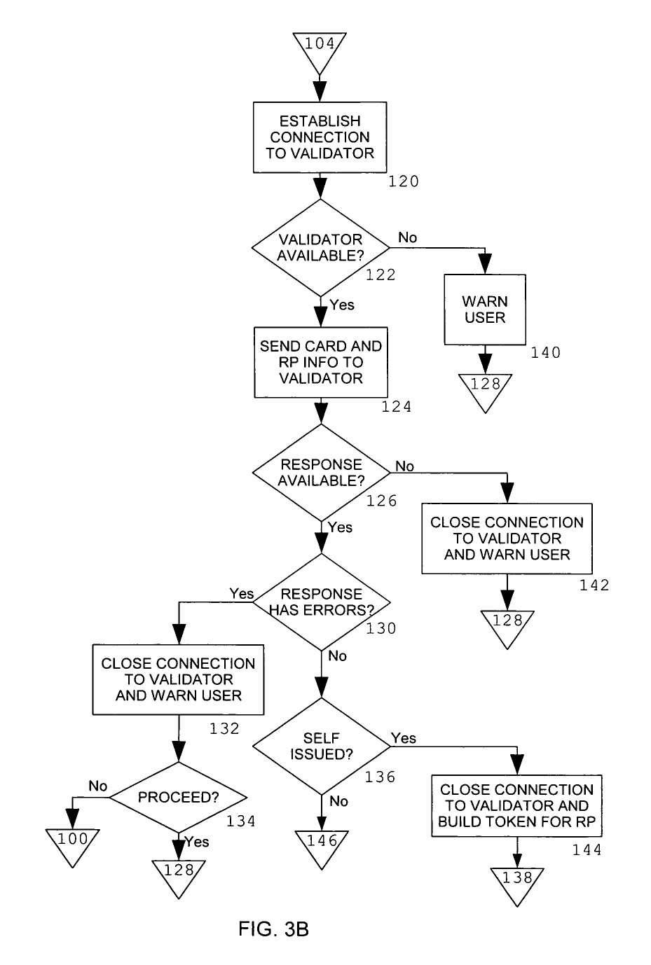

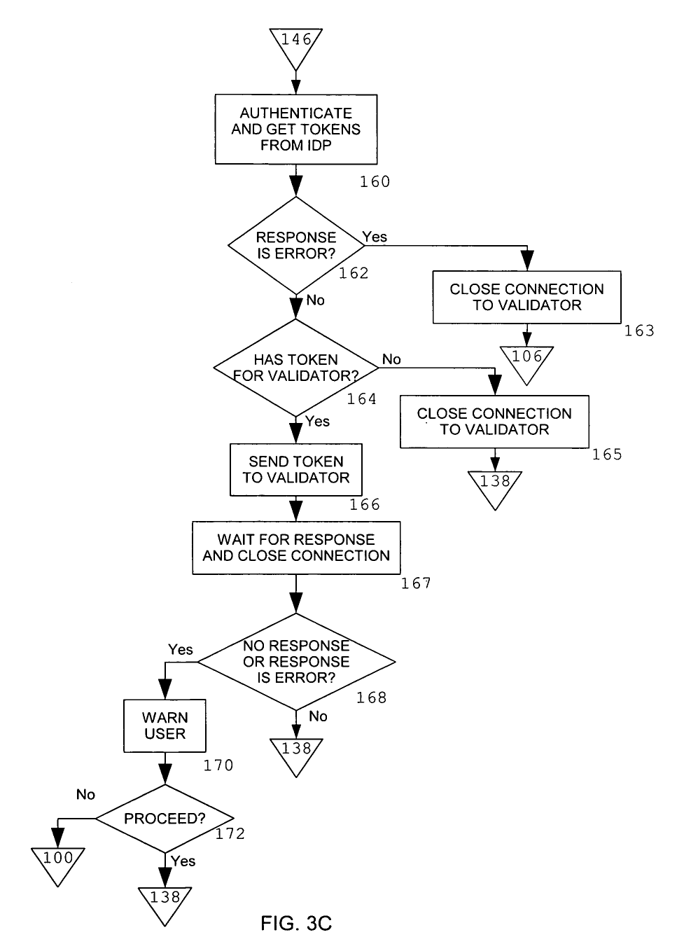

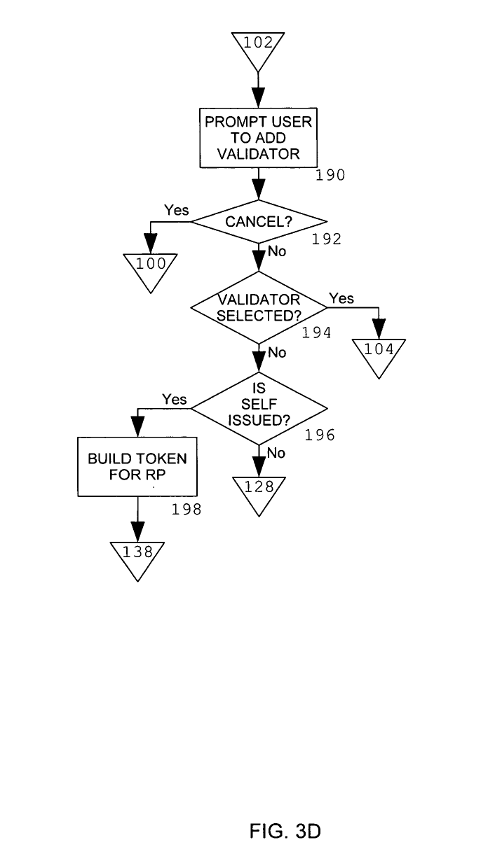

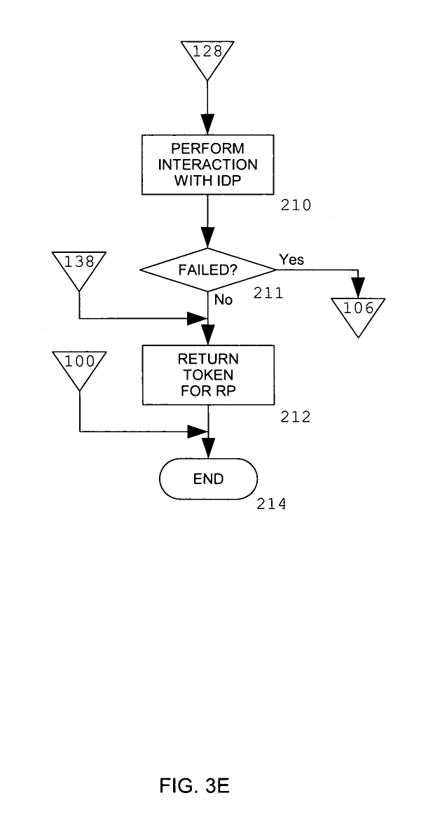

FIG. 3A, FIG. 3B, FIG. 3C, FIG. 3D and FIG. 3E are a flowchart illustrating the behavior of an identity selector component (32).

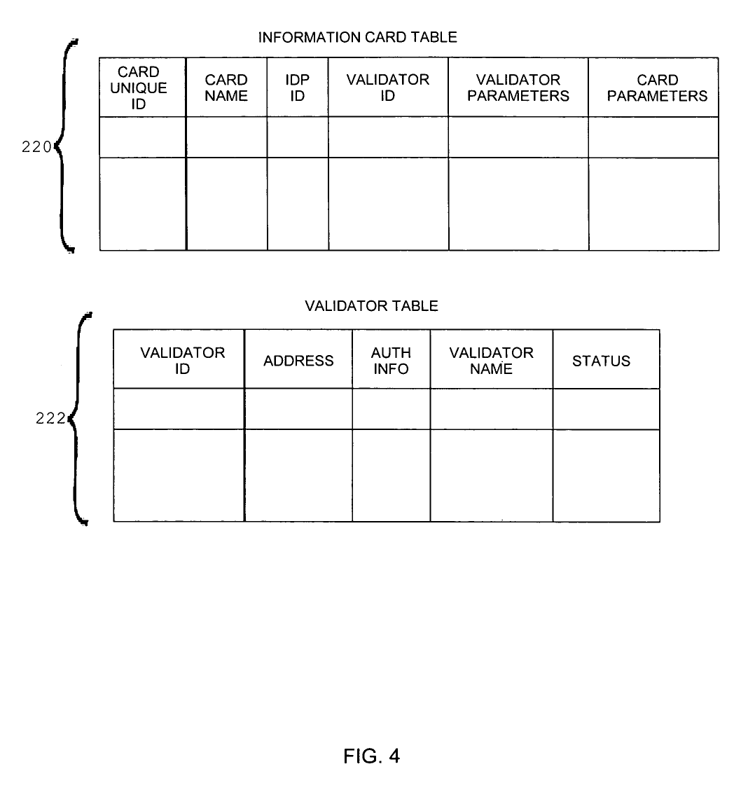

FIG. 4 is a diagram illustrating the tables of a card database component (30).

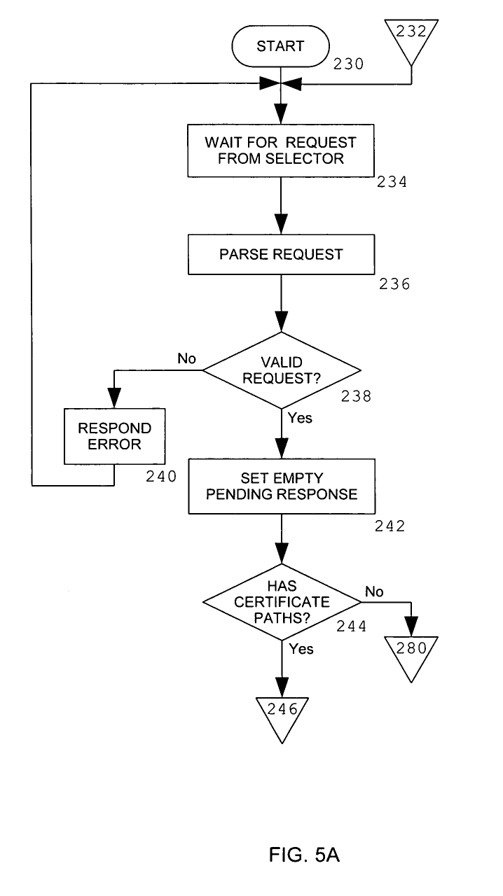

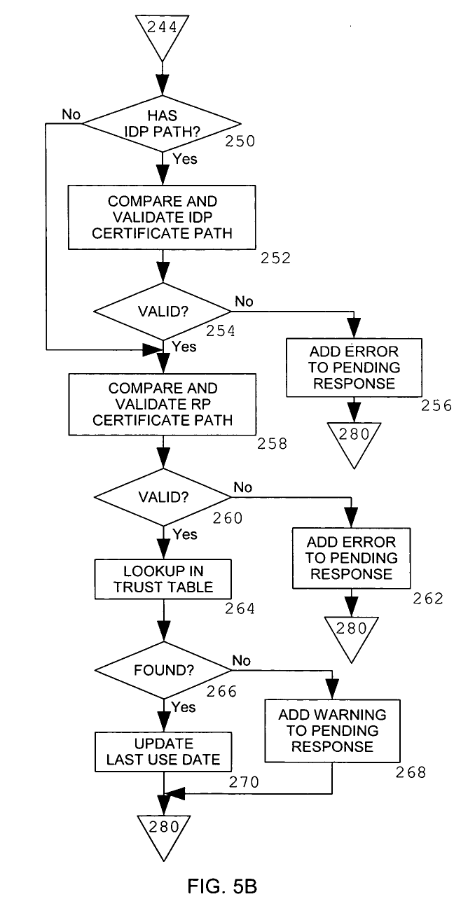

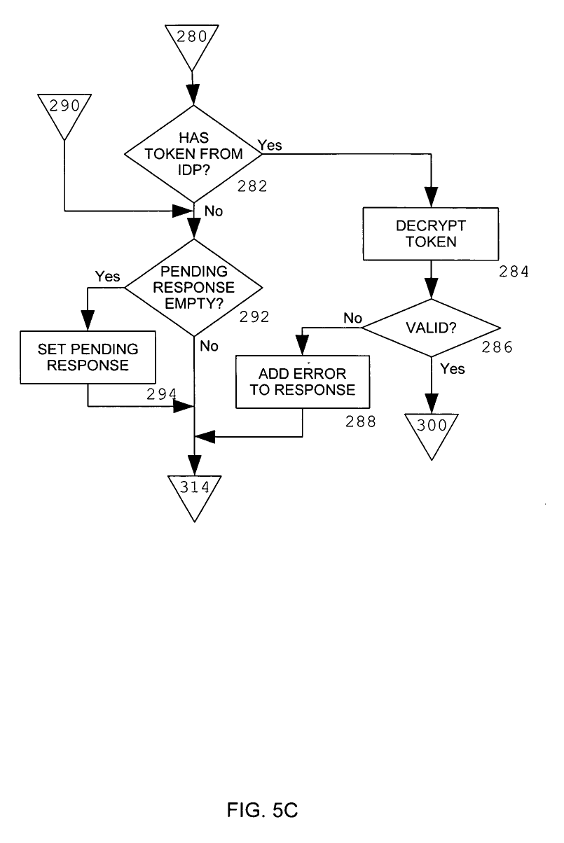

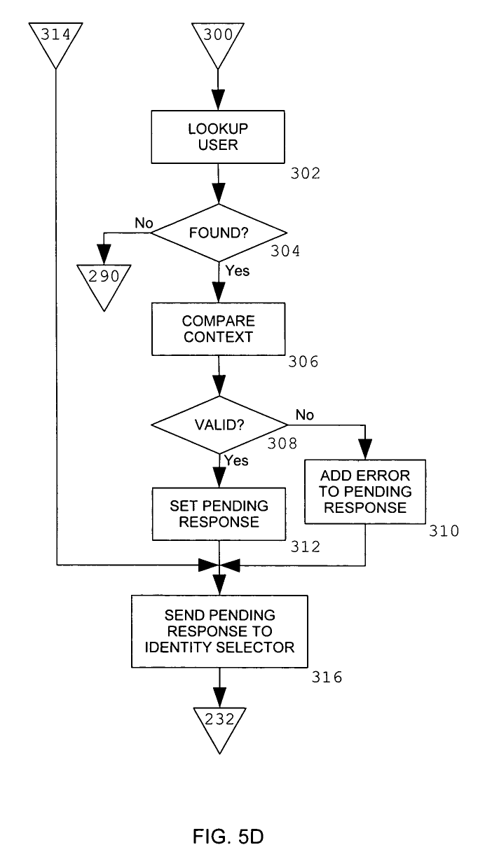

FIG. 5A, FIG. 5B, FIG. 5C and FIG. 5D are a flowchart illustrating the behavior of a validator responder component (24).

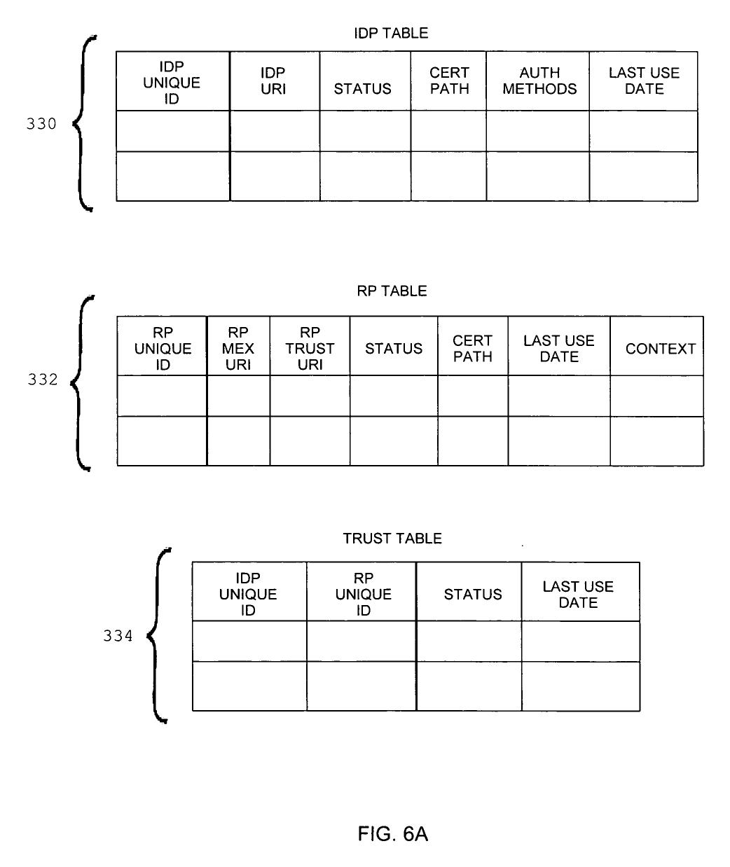

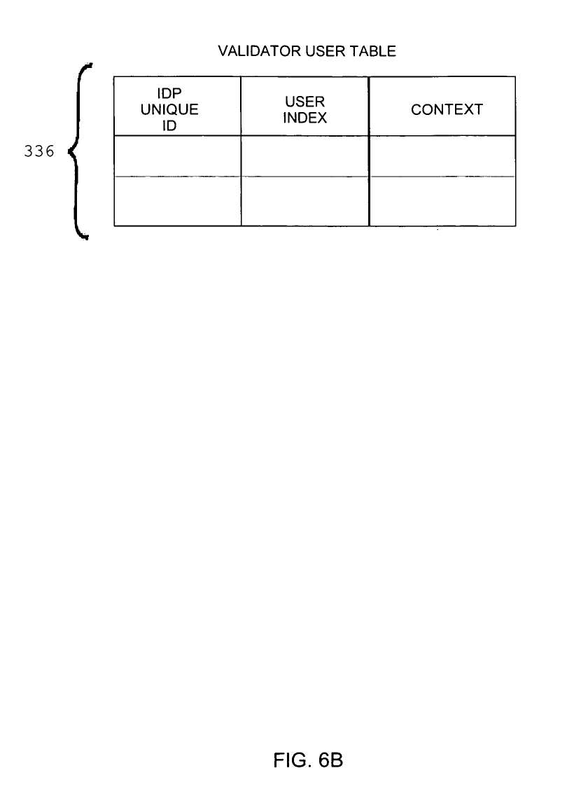

FIG. 6A and FIG. 6B are diagrams illustrating the tables of the validator database component (22).

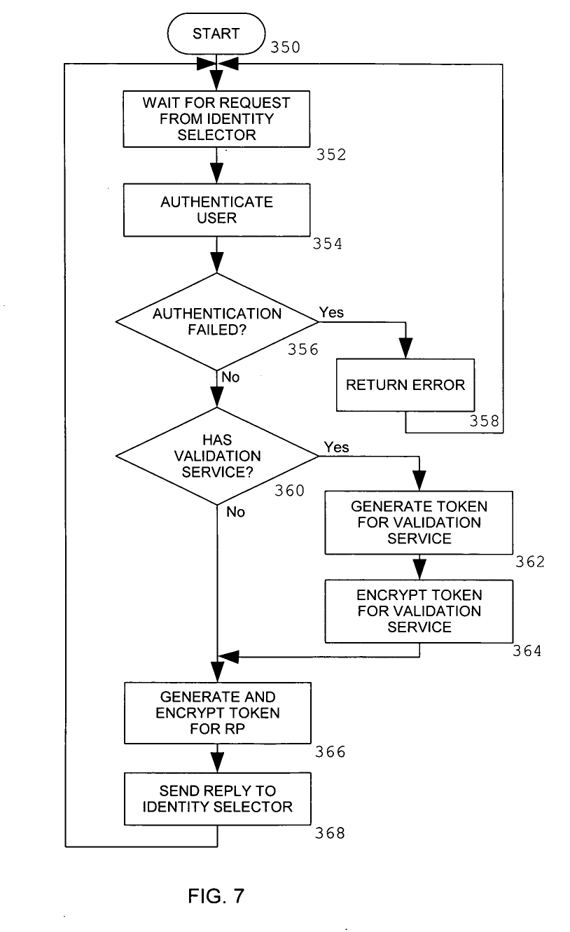

FIG. 7 is a flowchart illustrating the behavior of an identity provider application component (18).

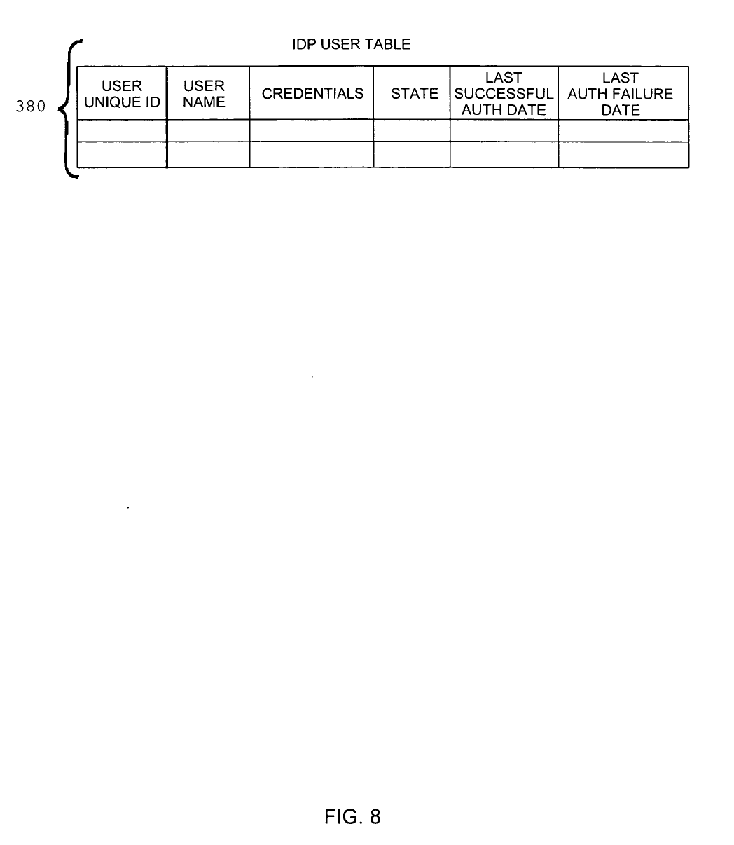

FIG. 8 is a diagram illustrating the table of the identity provider credentials database component (10).

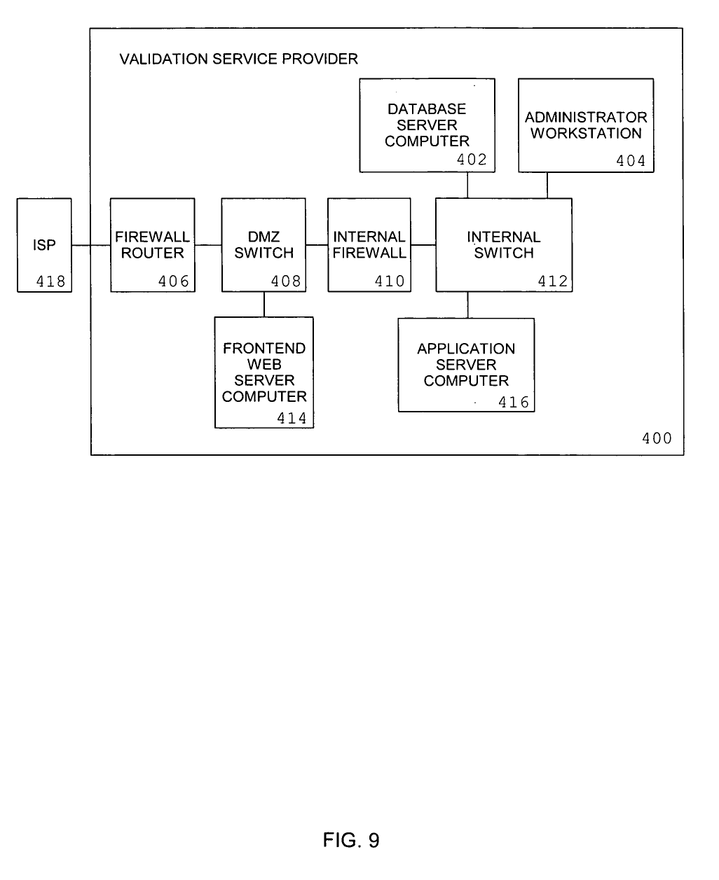

FIG. 9 is a diagram illustrating components of a validation service provider computer network.

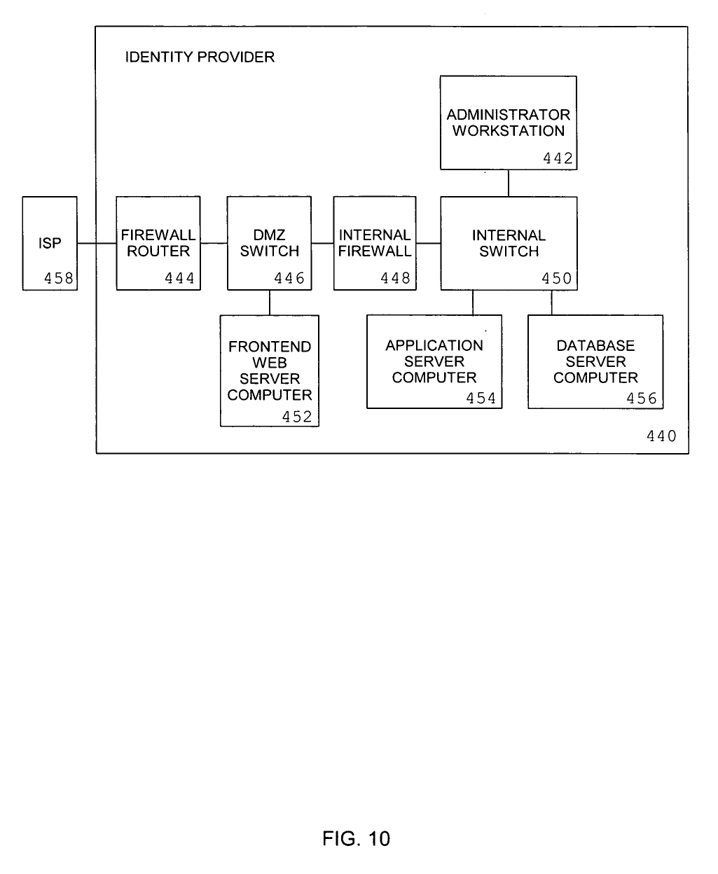

FIG. 10 is a diagram illustrating components of an identity provider computer network.

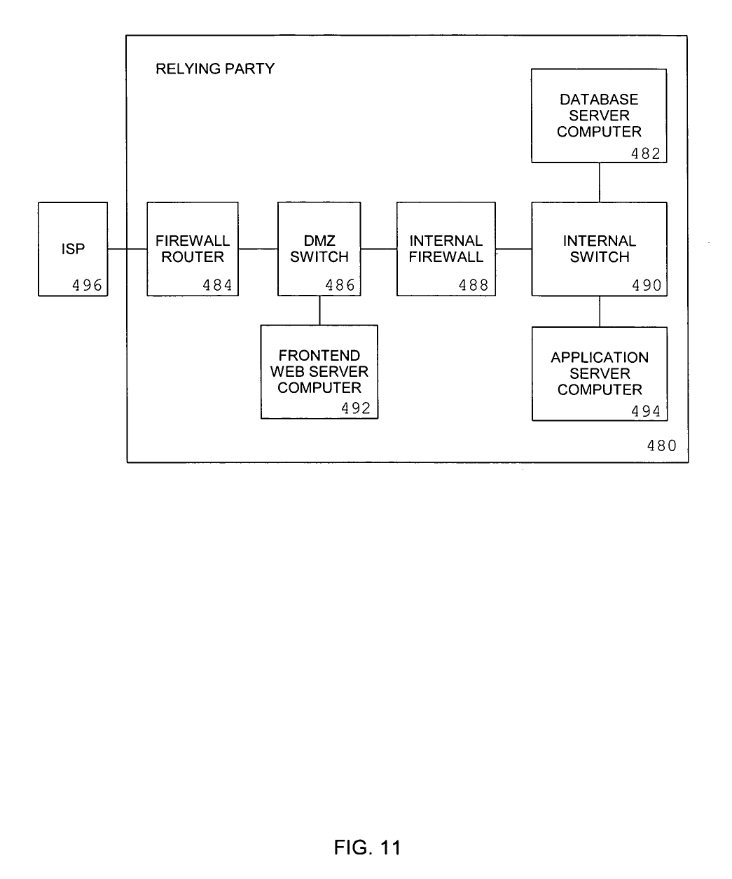

FIG. 11 is a diagram illustrating components of a relying party computer network.

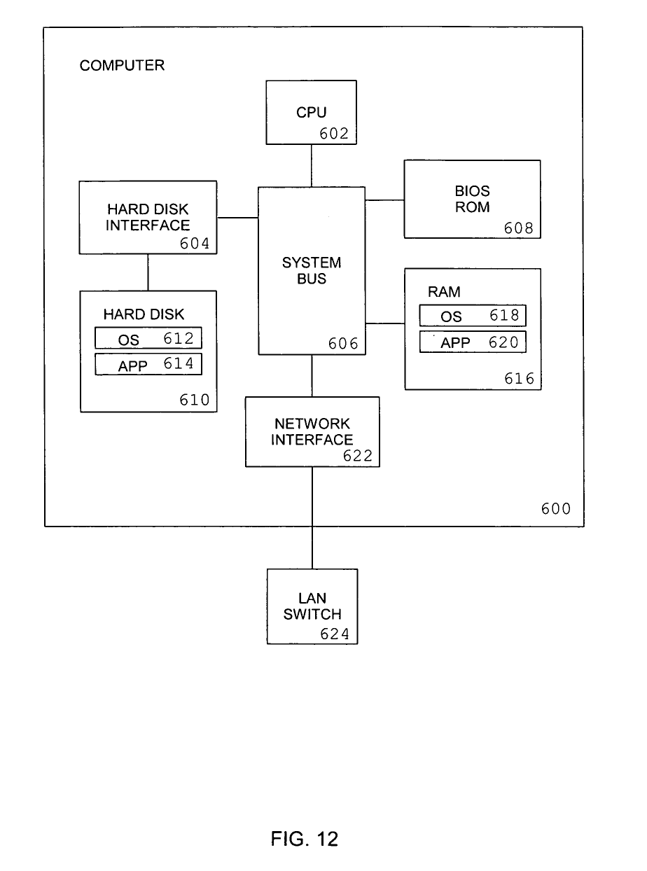

FIG. 12 is a diagram illustrating components of a server computer.

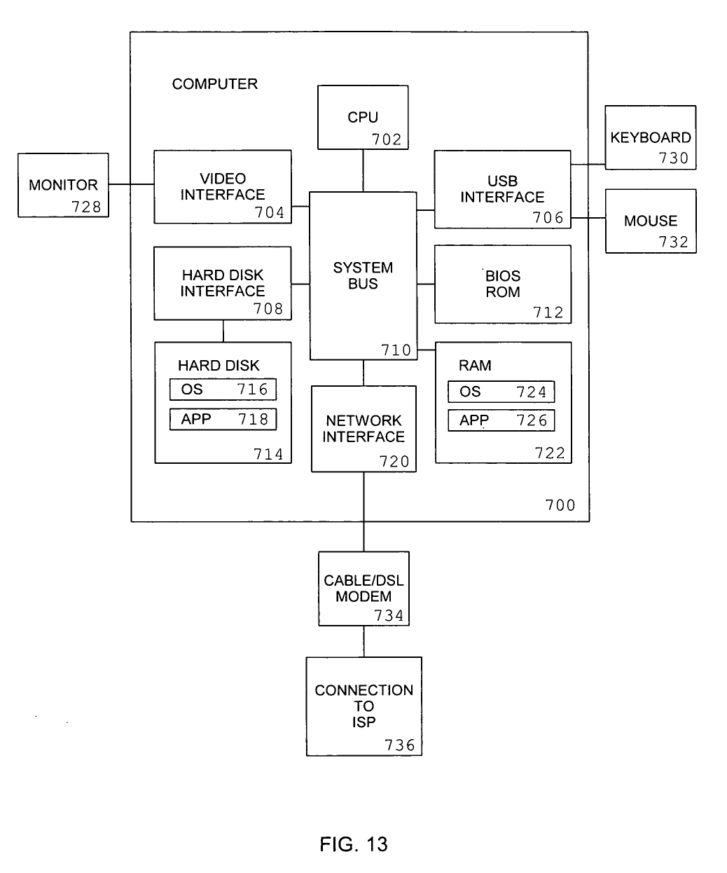

FIG. 13 is a diagram illustrating components of a workstation computer.

### REFERENCE NUMERALS

10 identity provider credentials database component
11 identity provider
12 certification authority
14 administrator
16 relying party provider database component
17 relying party
18 identity provider application component
20 validation service
22 validator database component
24 validator responder component
26 relying party application component
28 client
30 client card database component
32 client identity selector component
34 client web browser component
36 user
50 identity provider credentials database component
51 identity provider
52 relying party provider database component
53 relying party
54 identity provider application component
56 relying party application component
57 client
58 client card database component
60 client identity selector component
62 client web browser component
64 user
220 information card table
222 validator table
330 idp table
332 rp table
334 trust table
336 validator user table
380 idp user table
400 validation service provider
402 database server computer
404 administrator workstation computer
406 firewall router
408 DMZ switch
410 internal firewall
412 internal switch
414 frontend web server computer
416 application server computer
418 ISP
440 identity provider
442 administrator workstation computer
444 firewall router
446 DMZ switch
448 internal firewall
450 internal switch
452 frontend web server computer
454 application server computer
456 database server computer
458 ISP
480 relying party
482 database server computer
484 firewall router
486 DMZ switch
488 internal firewall
490 intranet switch
492 frontend web server computer
494 application server computer
496 ISP
600 computer
602 CPU
604 hard disk interface
606 system bus
608 BIOS ROM
610 hard disk
612 operating system software on hard disk
614 application software on hard disk
616 RAM
618 operating system software in memory
620 application software in memory
622 network interface
624 LAN switch
700 computer
702 CPU
704 video interface
706 USB interface
708 hard disk interface
710 system bus
712 BIOS ROM
714 hard disk
716 operating system software on hard disk
718 application software on hard disk
720 network interface
722 RAM
724 operating system software in memory
726 application software in memory
728 monitor
730 keyboard
732 mouse
734 cable/DSL modem
736 connection to ISP

### DETAILED DESCRIPTION

This system comprises the following major components:
an identity provider (11),
a relying party (17),
a certification authority (12),
a validation service (20), and
a client (28).

The identity provider (11) is a network service which performs authentications of users. This service comprises a credentials database component (10) and an application component (18).

The identity provider credentials database component (10) can be implemented as a relational database. There is one table in this database, the idp user table (380).

The idp user table (380) in the identity provider credentials database has one row for each user whose identity account is managed by the identity provider. The primary key of this table is the USER UNIQUE ID column. The columns of this table are:
USER UNIQUE ID: a unique identifier for the user,
USER NAME: the username of the user,
CREDENTIALS: the authentication credentials for the user, such as a password,
STATE: the status of the user's account,
LAST SUCCESSFUL AUTH DATE: the date and time that the user last successfully authenticated, and
LAST AUTH FAILURE DATE: the date and time that the user last supplied incorrect credentials during authentication.

The identity provider application component (18) is a network service that authenticates users. The behavior of this component is illustrated by the flowchart of FIG. 7.

The relying party (17) is a network service which relies upon an identity provider (11) to authenticate users. This service comprises a provider database (16) and an application component (26).

The relying party provider database component (16) can be implemented as a relational database. The tables of this database store an index of the users of the relying party service, in which the user identifier comprises an identifier for the identity provider and an identifier for the user that is generated by an identity provider.

The relying party application component (26) is a network service that is contacted by the client web browser (34). The relying party application component is typically implemented as software running on a web server or as a web service provided by software running on an application server.

The certification authority (12) issues X.509 public key certificates to the identity provider application component (18), the validation responder component (24) and the relying party application component (26). It is necessary for the identity provider application component (18), the validation responder component (24) and the relying party application component (26) to have X.509 certificates for use as Transport Layer Security (TLS) server certificates. The identity selector needs to have a copy of the certification authority's certificate as a trusted certificate to be able to perform a validation of the identity provider application component's certificate. Prior to the validation process, the identity provider application component, the validation responder component and the relying party application component will each have generated a public and private key pair, and the certification authority will have generated X.509 public key certificates which sign the identity and public key of each of these servers using the private key of the certification authority.

The validation service (20) is a network service that provides data to the identity selector (32) which assists the identity selector during the authentication process. This service comprises the following components: a validator database component (22) and a validator responder component (24).

The validation service validator database component (22) can be implemented as a relational database. There are four tables in this database: the idp table (330), the rp table (332), the trust table (334) and the validator user table (336).

The idp table (330) has one row for each identity provider known to the validation service. The primary key of this table is the IDP UNIQUE ID column. The columns of this table are:
IDP UNIQUE ID: a unique identifier for the identity provider,
IDP URI: the uniform resource identifier (URI) of the identity provider application service (18),
STATUS: an indication of whether the record for this identity provider is active, disabled or deleted,
CERT PATH: the set of X.509 certificates which form the certificate path of the identity provider application service to a top-level certification authority,
AUTH METHODS: a set of indications of each of the authentication methods supported by the identity provider for authenticating its users, and
LAST USE DATE: the date and time that this row was last used by the validation responder.

The rp table (332) has one row for each relying party known to the validation service. The primary key of this table is the RP UNIQUE ID column. The columns of this table are:
RP UNIQUE ID: a unique identifier for the relying party,
RP MEX URI: the URI for the WS-MetadataExchange endpoint of the relying party application component (26),
RP TRUST URI: the URI for the WS-Trust endpoint of the relying party application component (26),
STATUS: an indication of whether the row for this relying party is active, disabled or deleted,
CERT PATH: the set of X.509 certificates which form the certificate path of the relying party application service to a top-level certification authority,
LAST USE DATE: the date and time that this row was last used by the validation responder, and
CONTEXT: an indication of the application context for this relying party.

The trust table (334) has one row for each relationship between an identity provider and a relying party known to the validation service. The primary key of this table is the combination of the IDP UNIQUE ID column and the RP UNIQUE ID column. The columns of this table are:
IDP UNIQUE ID: the unique identifier of the identity provider,
RP UNIQUE ID: the unique identifier of the relying party,
STATUS: an indication whether the row for this relationship is active, disabled or deleted, and
LAST USE DATE: the date and time that this row was last used by the validation service.

The validator user table (336) has one row for each user account known to the validation service. The primary key of this table is the combination of the IDP UNIQUE ID column and the USER INDEX column. The columns of this table are:
IDP UNIQUE ID: the unique identifier of the identity provider,
USER INDEX: a unique identifier for the user assigned by the identity provider, and
CONTEXT: an indication of the application context of this user account.

The validation service validator responder component (24) is a network service. This component is typically implemented as software running on a web server or as a web service provided by software running on an application server. The behavior of this component is illustrated by the flowchart of FIG. 5A, FIG. 5B, FIG. 5C and FIG. 5D.

The client (28) is typically a single computer system, such as a laptop or other mobile device. The client comprises the following three components: a card database component (30), an identity selector component (32), and a web browser component (34).

The card database component (30) can be implemented as a relational database. There are two tables in this database: the information card table (220) and the validator table (222).

The information card table (220) has one row for each information card stored in the card database. The primary key of this table is the CARD UNIQUE ID column. The columns of this table are:
CARD UNIQUE ID: a unique identifier for the information card,
CARD NAME: a short string comprising a name for the information card,
IDP ID: the unique identifier for the identity provider that issued this information card, or NULL if the card is self-issued,
VALIDATOR ID: the unique identifier for the validation service to contact for interactions involving this card, or NULL if no service is to be contacted,
VALIDATOR PARAMETERS: a set of parameters to provide to the validation service, and
CARD PARAMETERS: a set of parameters of the information card.

The validator table (222) has one row for each validation service known to the client. The primary key of this table is the VALIDATOR ID column. The columns of this table are:
VALIDATOR ID: a unique identifier for the validation service,
ADDRESS: the network address of the validation service,
AUTH INFO: authentication information of the client to access the validation service, or NULL if no authentication information is required,
VALIDATOR NAME: the name of the validation service, and
STATUS: an indication of the status of this row, whether it is active, disabled or deleted.

The identity selector component (32) is a component of the operating system of the client (28). The identity selector implements the client role of the InfoCard protocols, and authenticates the user to the user's identity provider. The behavior of this component is illustrated by the flowchart of FIG. 3A, FIG. 3B, FIG. 3C, FIG. 3D and FIG. 3E.

The web browser component (34) is a system software component of the client (28). The web browser notifies the identity selector when a user has selected to authenticate to an InfoCard-capable relying party application (26), and forwards a token returned by the identity selector to that relying party application.

The diagram of FIG. 9 illustrates a typical deployment of the network components of a validation service provider (20). The validation service provider network comprises two local area networks (LANs). The DMZ LAN comprises an Ethernet switch (408), a frontend web server computer (414), a firewall router (406) with a connection to an Internet service provider (418), and an internal firewall (410). The internal LAN comprises an Ethernet switch (412), the internal firewall (410), an application server computer (416), a database server computer (402) and an administrator workstation (404). The validator database (22) can be implemented as software running on the database server computer (402). The interface to the administrator (14) can be implemented as software running on the administrator workstation (404). The validator responder (24) can be implemented as software running on the application server computer (416). Requests from identity selectors (32) are sent across the Internet to the frontend web server computer (414), which forwards them through the internal firewall (410) to the application server computer (416).

The diagram of FIG. 10 illustrates a typical deployment of the network components of an identity provider (11). The identity provider network comprises two local area networks. The DMZ LAN comprises an Ethernet switch (446), a frontend web server computer (452), a firewall router (444) with a connection to an Internet service provider (458), and an internal firewall (448). The internal LAN comprises an Ethernet switch (450), the internal firewall (448), an administrator workstation (442), an application server computer (454) and a database server computer (456). The credentials database (10) can be implemented as software running on the database server computer (456). The identity provider application (18) can be implemented as software running on the application server computer (454). Requests from identity selectors (32) are sent across the Internet to the frontend web server computer (452), which forwards them through the internal firewall (448) to the application server computer (454).

The diagram of FIG. 11 illustrates a typical deployment of the network components of a relying party (17). The relying party network comprises two local area networks. The DMZ LAN comprises an Ethernet switch (486), a frontend web server computer (492), a firewall router (484) with a connection to an Internet service provider (496), and an internal firewall (488). The internal LAN comprises an Ethernet switch (490), the internal firewall (488), a database server computer (482) and an application server computer (494). The provider database (16) can be implemented as software running on the database server computer (482). The relying party application component (26) can be implemented as software running on the application server computer (494). Requests from web browsers (34) are sent across the Internet to the frontend web server computer (492), which forwards them through the internal firewall (488) to the application server computer (494).

The diagram of FIG. 12 illustrates the typical components of a computer for running server software applications. The components of the computer (600) include a central processing unit (602), a hard disk interface (604) to a hard disk (610), a system bus (606), a BIOS ROM (608), random access memory (616), and a network interface (622) to a LAN switch (624). The hard disk stores the persistent state of the operating system (612) and server applications (614). The random access memory holds the currently running software and state of the operating system (618) and server applications (620).

The diagram of FIG. 13 illustrates the typical components of a computer for running client software applications. The components of the computer (700) include a central processing unit (702), a hard disk interface (708) to a hard disk (714), a system bus (710), a BIOS ROM (712), random access memory (722), a video interface (704) to a monitor (728), a USB interface (706) to a keyboard (730) and mouse (732), and a network interface (720) to a cable or DSL modem (734). The hard disk stores the persistent state of the operating system (716) and applications (718). The random access memory holds the currently running software and state of the operating system (724) and applications (726).

### Operation

The behavior of an identity selector (32) in this invention is illustrated by the flowchart of FIG. 3A, FIG. 3B, FIG. 3C, FIG. 3D and FIG. 3E. This component comprises a single thread of control. The thread is triggered to start by the web browser application component (34). The web browser component provides to the thread as input the token and claims requirements of the relying party application component (26). The thread returns to the web browser either an indication to cancel the interaction with the relying party, or a token for the web browser to send to the relying party component.

At step 82, the thread will load the set of cards from the card database (30) into memory. At step 84, the thread will select from this set the cards that meet the requirements of the relying party application component (26), and will display these cards to the user (36). At step 86, the thread will wait for the user to make a selection, in which the user has the options to select a card, to create a new self-issued card, or to cancel. If the user selected to cancel, then the thread will end. Otherwise, if the user selected to create a new self-issued card, then the thread will continue processing at step 92. Otherwise, if the card selected by the user does not have validation parameters, then the thread will continue processing at step 190. Otherwise, the user has selected a card that has validation parameters, and the thread will continue at step 120.

At step 92, the thread will wait for the user to supply the claim parameters of the new self-issued card. If the user did not supply the parameters and canceled the interaction, then the thread will end. Otherwise, at step 96 the thread will add the new self-issued card as a row in the information card table (220). The thread will then loop back to continue processing at step 84.

At step 120, the thread will establish a HTTPS connection to the validator responder component (24), at the network address specified in the ADDRESS column of the row of the validation service in the validator table (222). If there is a value in the AUTH INFO column of that row, then the thread will use this information to perform a HTTP authentication to the validator responder. If the connection could not be established, then at step 140 the thread will warn the user, and continue processing at step 210. Otherwise, at step 124 the thread will send the parameters of the card and the relying party parameter to the validator over this connection, and wait for a response. If a response from the validator was not available, then at step 142 the thread will close the connection to the validator, warn the user, and then the thread will continue processing at step 210. If the response from the validator had error indications, then the thread will continue processing at step 132. If the card was self-issued, then at step 144 the thread will close the connection to the validator, build a token for the relying party, and continue processing at step 212. Otherwise, if the card was not self-issued, then the thread will continue processing at step 160.

At step 132, the thread will close the connection to the validator, warn the user by displaying the returned error indications, and wait for the user's response. If the user chooses to not proceed, then the thread will end. Otherwise, the thread will continue processing at step 210.

At step 160, the thread will authenticate to the identity provider, and wait for a response comprising either an error indication or a set of one or more tokens from that identity provider. If the response from the identity provider was an error, then at step 163 the thread will close the connection to the validator, and then the thread will loop back to continue processing at step 84. If the response from the identity provider did not include any token for the validator, then at step 165 the thread will close the connection to the validator, and the thread will continue processing at step 212. Otherwise, at step 166 the thread will send this token to the validator over the connection. At step 167, the thread will wait for a response from the validator, and close the connection to the validator. If there was a response from the validator and the response did not have an error indication, then the thread will continue processing at step 212. Otherwise, at step 170 the thread will warn the user by displaying any returned error indications, and wait for the user's response. If the user chooses to not proceed, then the thread will end. Otherwise, the thread will continue processing at step 212.

At step 190, the thread will prompt the user to add a validator, by displaying the set of validation services known to the client in the validator table (222). If the user selected to cancel the interaction, then the thread will end. Otherwise, if the user selected a validator, then the thread will continue processing at step 120. If the card was self-issued, then at step 198 the thread will build a token for the relying party, and then the thread will continue processing at step 212. Otherwise, the thread will continue processing at step 210.

At step 210, the thread will perform an authentication protocol exchange with the identity provider. If the authentication failed, then the thread will loop back to step 84. At step 212, the thread will return to the web browser a token for the relying party, and the thread will then end.

The behavior of a validator responder component (24) is illustrated by the flowchart of FIG. 5A, FIG. 5B, FIG. 5C and FIG. 5D. This component comprises one or more threads of control.

At step 234, the thread will wait for an incoming request from the identity selector. If there is more than one thread of control present in the component, then an incoming request from an identity selector is provided to exactly one thread. At step 246, the thread will parse the request. If the request is not valid, then at step 240 the thread will respond error, and loop back to step 234. At step 242, the thread will set an empty pending response. If the request includes a relying party certificate path or an identity provider certificate path, then the thread will continue processing at step 250. Otherwise, the thread will continue processing at step 282.

At step 250, the thread will test whether the request includes an identity provider certificate path. If the request includes an identity provider certificate path, then at step 252 the thread will validate the set of certificates in the identity provider certificate path, and search the idp table (330) for a row in which the value of the CERT PATH column matches that certificate path and the value of the STATUS column is NULL. If the path is not valid or a row is not found, then at step 256 the thread will add an error indication to the pending response, and continue processing at step 282. Otherwise, the thread will update the value of the LAST USE DATE column in that row. At step 258, the thread will validate the set of certificates in the relying party certificate path, and search the rp table (332) for a row in which the value of the CERT PATH column matches that certificate path and the value of the STATUS column is NULL. If the path is not valid or a row was not found, then at step 262 the thread will add an error indication to the pending response, and continue processing at step 282. Otherwise, the thread will update the value of the LAST USE DATE column in that row, and at step 264 the thread will search the trust table (334) for a row in which the identity provider and relying party unique identifiers match that of the unique identifiers of the identity provider and relying party rows, and the value of the STATUS column is NULL. If a row was not found, then at step 268 the thread will add a warning to the pending response. Otherwise, if a row was found, then at step 270 the thread will update the value of the LAST USE DATE column in that row with the current date and time. The thread will then continue processing at step 282.

At step 282, the thread will test whether the request includes a token from the identity provider which is encrypted with the public key of the validation service. If the request includes such a token, then the thread will continue processing at step 284. If the pending response is empty, then at step 294 the thread will set the pending response to indicate “in progress” and continue processing at step 316. Otherwise, the thread will continue processing at step 316.

At step 284, the thread will decrypt the token from the identity provider using its private key. If the token was not valid or could not be decrypted, then at step 288, the thread will add an error indication to the pending response and continue processing at step 314. Otherwise, at step 302 the thread will search the validator user table (336) for a row in which the value IDP UNIQUE ID column matches that of the identity provider and the value of the USER INDEX column matches that of the user index obtained from the decrypted token. If a row for a user was not found, then the thread will continue processing at step 292. Otherwise, at step 306 the thread will compare the context obtained from the value of the CONTEXT column with that of the CONTEXT column in a row obtained from the rp table (332). If the combination of these contexts is not valid (the values do not match), then at step 310 the thread will add an error indication to the pending response and continue processing at step 316. If the context combination was valid, then at step 312 the thread will set the pending response to success and continue processing at step 316.

At step 316, the thread will send the pending response to the identity selector. The thread will then loop back to step 234.

The behavior of an identity provider application component (18) is illustrated by the flowchart of FIG. 7. The component comprises one or more threads of control.

At step 352, the thread will wait for a request from the identity selector. If there is more than one thread of control in this component, then each request is provided to exactly one thread. At step 354, the thread will authenticate the user by searching the idp user table (380) for a row in which the value of the USER NAME matches that of the request, and the value of the CREDENTIALS column matches the presented credentials from the request. If the authentication failed, then at step 358 the thread will return an error to the identity selector, and then the thread will loop back to step 352. Otherwise, at step 360 the thread will test whether the request includes a certificate path of a validation service. If the request includes a certificate path of a validation service, then at step 362 the thread will generate token for the validation service which comprises the user unique id of the authenticated user, and at step 364 the thread will encrypt the token for the validation service with the public key of the validation service obtained from the certificate path. At step 366, the thread will generate and encrypt a token for the relying party, as described in the document “A Technical Reference for the Information Card Profile V1.0”. At step 368, the thread will send a reply to the identity selector containing the generated and encrypted token or pair of tokens, and then the thread will loop back to step 352.

### CONCLUSIONS

Many different embodiments of this invention may be constructed without departing from the scope of this invention. While this invention is described with reference to various implementations and exploitations, and in particular with respect to systems for authentication in computer networks, it will be understood that these embodiments are illustrative and that the scope of the invention is not limited to them.

What is claimed is:

1. A method for validating interactions between a user, an identity provider and a relying party in an identity metasystem, said method comprising:
(a) accessing said relying party from a web browser on behalf of said user,
(b) transferring a relying party identity from said relying party to said web browser,
(c) transferring said relying party identity from said web browser to an identity selector,
(d) retrieving from a card database a user identity,
(e) authenticating a user with said user identity at said identity provider,
(f) generating at said identity provider a token for a validation service,
(g) transferring said token from said identity provider to said identity selector,
(h) transferring a request comprising said token and said relying party identity from said identity selector to said validation service,
(i) searching in a database of said validation service for a record set corresponding to said token and said relying party identity,
(j) generating at said validation service a response based on said request and said record set from said search,
(k) transferring said response from said validation service to said identity selector, and
(l) informing said user of said response.

2. The method of claim 1, wherein said generating at said identity provider said token comprises encrypting an identity of said identity provider and an identity of said user with a key of said validation service.

3. The method of claim 2, wherein said searching of said database comprises comparing said identity of said identity provider, said identity of said user and said relying party identity with a record in said database of said validation service.

4. The method of claim 1, wherein said authenticating of said user comprises comparing a user identity and a password provided by said identity selector with a record in a database of said identity provider.

5. A system for validating interactions between a user, an identity provider and a relying party in an identity metasystem, said system comprising:
(a) said user,
(b) said identity provider,
(c) said relying party,
(d) a web browser,
(e) an identity selector,
(f) a card database,
(g) a validation service, and
(h) a database of said validation service, wherein
said web browser accesses said relying party on behalf of said user,
said relying party returns a relying party identity to said web browser,
said web browser transfers said relying party identity to said identity selector,
said identity selector retrieves a user identity from said card database,
said identity provider authenticates said user with said user identity,
said identity provider generates a token for said validation service,
said identity provider transfers said token to said identity selector,
said identity selector transfers a request comprising said token and said relying party identity to said validation service,
said validation service searches in said database of said validation service for a record set corresponding to said token and said relying party identity,
said validation service generates a response based on said request and said record set from said search,
said validation service transfers said response to said identity selector, and
said identity selector informs said user of said response.

6. The system of claim 5, wherein said validation service is implemented as software running on a general purpose computer system.

7. The system of claim 5, wherein said web browser, said identity selector, and said card database are implemented as software running on a general purpose computer system.

8. The system of claim 5, wherein said relying party identity comprises a public key certificate.

9. The system of claim 5, wherein said token comprises an identity of said identity provider and an identity of said user encrypted with a key of said validation service and encoded in a security assertion markup language.

10. A computer program product within a computer usable medium with software for validating interactions between a user, an identity provider and a relying party in an identity metasystem, said product comprising:
(a) instructions for accessing said relying party from a web browser on behalf of said user,
(b) instructions for transferring a relying party identity from said relying party to said web browser,
(c) instructions for transferring said relying party identity from said web browser to an identity selector,
(d) instructions for retrieving from a card database a user identity,
(e) instructions for authenticating a user with said user identity at said identity provider,
(f) instructions for generating at said identity provider a token for a validation service,
(g) instructions for transferring said token from said identity provider to said identity selector,
(h) instructions for transferring a request comprising said token and said relying party identity from said identity selector to said validation service,
(i) searching in a database of said validation service for a record set corresponding to said token and said relying party identity,
(j) generating at said validation service a response based on said request and said record set from said search,
(k) instructions for transferring said response from said validation service to said identity selector, and
(l) instructions for informing said user of said response.
